(19) United States
(12) Patent Application Publication
(10) Pub. No.: US 2023/0010990 A1
(43) Pub. Date: Jan. 12, 2023

(54) SYSTEM AND METHOD FOR PROVIDING COMMUNICATIONS SERVICES ON BOTH SIDES OF A CORRIDOR

(71) Applicant: POYNTING ANTENNAS (PTY) LIMITED, Samrand, Centurion, Pretoria (ZA)

(72) Inventor: Andries Petrus Cronje FOURIE, Johannesburg (ZA)

(21) Appl. No.: 17/779,999

(22) PCT Filed: Nov. 27, 2020
(86) PCT No.: PCT/IB2020/061209

§ 371 Date: May 25, 2022

(30) Foreign Application Priority Data
Nov. 29, 2019 (ZA) 2019/08129

(51) Int. Cl. H04B 7/145; H01Q 19/10; H01Q 25/00

(52) U.S. Cl. CPC H04B 7/145; H01Q 19/106; H01Q 25/00

(57) ABSTRACT

A system 10 for providing communication services to user stations 14.1 to 14.n which are spaced on each of a first side 16 and a second side 18 of a corridor 12. The system comprises at least one corridor node 20. The corridor node comprises a radio transceiver arrangement 54 and a spaced reflector 70. The transceiver arrangement is connected to an antenna arrangement 58, which comprises a reflective feed antenna 67. The antenna arrangement has a radiation pattern comprising an elongate lobe 30, having a main axis 38, which illuminates user stations associated with the corridor node on one of the first side and the second side. The spaced reflector reflects signals 88 impinging from the reflective feed antenna in accordance with a reflected radiation pattern, comprising one reflected lobe 34, having a main axis 42, for illuminating user stations associated with the corridor node on the other of the first side and the second side.

### INTRODUCTION AND BACKGROUND

This invention relates to a communication system and to a method of providing communication services to a plurality of spaced user stations, such as houses and/or offices in a built-up area.

Fibre to the X (FTTX) is a known technology for the so-called last mile where optical fibre cables are provided between a distribution point and each of a plurality of end user stations in a built-up area. To provide these cables in a built-up area, such as suburb or the like, trenches need to be dug on both sides of a street to locate main fibre branches in the trenches. Connection points are provided at each user station along the length of each main branch, so that the user stations may be connected by fibre sub-branches to the main branch in the trench. It will be appreciated that the roll out of such a system is time and labour intensive, causes inconvenience to inhabitants and is also expensive.

In the applicant's WO 2018/142236 A1 there is disclosed and claimed an invention entitled “System and method for providing communications services on both sides of a corridor”. The system comprises a plurality of corridor nodes provided in spaced relation along the corridor. The nodes comprise respective radio transceivers connected to associated antenna arrangements. In some example embodiments, the antenna arrangement of each node has a radiation pattern comprising at least a first, a second, a third and a fourth elongate main lobe having a respective main axis, as more fully described in the specification of the above WO 2018/142236 A1. In some example embodiments, each node comprises first and second transceivers and associated antenna arrangements mounted directly opposite one another on either side of the corridor, to generate the first to fourth lobes. These example embodiments may not be best suited for some applications.

### OBJECT OF THE INVENTION

Accordingly, it is an object of the present invention to provide an alternative system for and method of providing communications services to user stations in a built-up area which the applicant believes may provide a useful alternative for the known systems and methods.

### SUMMARY OF THE INVENTION

According to the invention there is provided a system for providing communication services to user stations which are spaced on each of a first side and a second opposed side of an elongate corridor having a longitudinal axis and extending between an upstream region and a downstream region, the system comprising at least a first corridor node comprising:
a first radio transceiver arrangement which is connected to a first antenna arrangement, the first radio transceiver arrangement generating radio signals in a first frequency band, the first antenna arrangement having a first radiation pattern comprising at least a first elongate lobe having a main axis, the at least first elongate lobe, in use, illuminating user stations associated with the first corridor node on one of the first side and the second side of the corridor, and the first antenna arrangement comprising a reflective feed antenna; and
a first spaced reflector associated with the first antenna arrangement and for reflecting signals impinging from the reflective feed antenna in accordance with a first reflected radiation pattern comprising at least one reflected lobe for illuminating user stations associated with the first corridor node on the other of the first side and the second side of the corridor.

The term radiation pattern is used in this specification to refer to the directional (angular) dependence of the strength of the radio waves or signals from the antenna or other source. The radiation pattern may be represented graphically as a plot of one of a number of related variables, including: the field strength (an amplitude pattern or field pattern), the power per unit solid angle (power pattern) and the directive gain.

It is a fundamental property of antennas that the receiving pattern (sensitivity as a function of direction) of an antenna when used for receiving is identical to the far-field radiation pattern of the antenna when used for transmitting. This is a consequence of the reciprocity theorem of electro-magnetism. Therefore, in references of radiation patterns in this specification, the antenna can be viewed as either transmitting or receiving, whichever is more appropriate.

The first antenna arrangement and the first spaced reflector may be located on a line extending transversely to the longitudinal axis of the corridor.

The first antenna arrangement may be located on the second side of the corridor and the first spaced reflector may be located on the first side of the corridor, directly opposite one another.

The first radiation pattern may comprise the first elongate lobe and a second elongate lobe having a main axis and which is angularly offset from the first elongate lobe.

The first antenna arrangement and first spaced reflector may be configured such that the main axis of the first elongate lobe is directed upstream towards a first region along the corridor which is on the first side of the corridor to illuminate user stations associated with the first corridor node between the first region and the first corridor node, the first elongate lobe being shaped such that gain is highest in the direction of the first region and such that the user stations associated with the first corridor node between the first region and the first corridor node which are progressively closer to the first corridor node are illuminated with progressively lesser gain; the main axis of the second elongate lobe is directed downstream towards a second region along the corridor which is on the first side of the corridor to illuminate user stations associated with the first corridor node between the second region and the first corridor node, the second elongate lobe being shaped such that gain is highest in the direction of the second region and such that the user stations associated with the first corridor node between the second region and the first corridor node which are progressively closer to the first corridor node are illuminated with progressively lesser gain; wherein the at least one reflected lobe comprises at least one of a third elongate lobe having a main axis and a fourth elongate lobe having a main axis, the main axis of the third elongate lobe being directed upstream towards a third region along the corridor which is on the second side of the corridor to illuminate user stations associated with the first corridor node between the third region and the first corridor node, the third elongate lobe being shaped such that gain is highest in the direction of the third region and such that the user stations associated with the first corridor node between the third region and the first corridor node which are progressively closer to the first corridor node are illuminated with progressively lesser gain; and the main axis of the fourth elongate lobe being directed downstream towards a fourth region along the corridor which is on the second side of the corridor to illuminate user stations associated with the first corridor node between the fourth region and the first corridor node, the fourth elongate lobe being shaped such that gain is highest in the direction of the fourth region and such that the user stations associated with the first corridor node between the fourth region and the first corridor node which are progressively closer to the first corridor node are illuminated with progressively lesser gain.

The system may comprise a directional antenna at each user station associated with the first corridor node and which directional antenna is aimed at the first corridor node.

The system may further comprise a second corridor node provided in spaced relation relative to the first corridor node along the corridor, the second corridor node comprising:
a second radio transceiver arrangement which is connected to a second antenna arrangement, the second radio transceiver arrangement may generate radio signals in a second frequency band, the second antenna arrangement may have a second radiation pattern comprising at least a first elongate lobe having a main axis, a second elongate lobe having a main axis and which second elongate lobe is angularly offset from the first elongate lobe, and the second antenna arrangement comprising a second reflective feed antenna;
a second spaced reflector associated with the second antenna arrangement and for reflecting signals impinging from the second reflective feed antenna in accordance with a second reflected radiation pattern comprising at least one reflected lobe of the second corridor node for illuminating user stations on the other of the first side and the second side of the corridor;
the second antenna arrangement and second spaced reflector being configured such that the main axis of the first elongate lobe is directed upstream towards a region along the corridor which is on the first side of the corridor to illuminate user stations associated with the second corridor node between said region and the second corridor node, the first elongate lobe being shaped such that gain is highest in the direction of said region and such that the user stations associated with the second corridor node between said region and the second corridor node which are progressively closer to the second corridor node are illuminated with progressively lesser gain; the main axis of the second elongate lobe is directed downstream towards a region along the corridor which is on the first side of the corridor intermediate the first and the second corridor nodes to illuminate user stations associated with the second corridor node between said region and the second corridor node, the second elongate lobe being shaped such that gain is highest in the direction of said region and such that the user stations associated with the second corridor node between said region and the second corridor node which are progressively closer to the second corridor node are illuminated with progressively lesser gain; wherein the at least one reflected lobe of the second corridor node comprises at least one of a third elongate lobe having a main axis and a fourth elongate lobe having a main axis, the main axis of the third elongate lobe being directed upstream towards a region along the corridor which is on the second side of the corridor to illuminate user stations associated with the second corridor node between said region and the second corridor node, the third elongate lobe being shaped such that gain is highest in the direction of said region and such that the user stations associated with the second corridor node between said region and the second corridor node which are progressively closer to the second corridor node are illuminated with progressively lesser gain; and the main axis of the fourth elongate lobe being directed downstream towards a region along the corridor which is on the second side of the corridor intermediate the first and the second corridor nodes to illuminate user stations associated with the second corridor node between said region and the second corridor node, the fourth elongate main lobe being shaped such that gain is highest in the direction of said region and such that the user stations associated with the second corridor node between said region and the second corridor node which are progressively closer to the second corridor node are illuminated with progressively lesser gain; and
a directional antenna at each user station associated with the second corridor node and which directional antenna is aimed at the second corridor node.

The first spaced reflector and second spaced reflector may have any suitable shape or configuration. For example, the spaced reflector may be V-shaped with an apex between first and second flanks of the spaced reflector.

The apex may be directed towards the associated antenna arrangement, the first flank, in use, may reflect impinging signals to direct the third elongate lobe as aforesaid and the second flank may, in use, reflect impinging signals to direct the fourth elongate lobe as aforesaid.

In other embodiments the spaced reflector may be convex in shape or configuration.

The first and second frequency bands may at least partially overlap.

Any one of a) the first radio transceiver arrangement and antenna arrangement and b) the second radio transceiver arrangement and antenna arrangement may be provided in a suitable housing.

The system may comprise at least the first corridor node, the second corridor node and a third corridor node provided sequentially in spaced relation along the corridor.

In respect of any one of the first radiation pattern and the second radiation pattern, the first elongate lobe may illuminate user stations on the first side of the corridor and may be shaped such that gain is a maximum on the main axis of the first lobe and decreases progressively in a first angular direction (such as clockwise), the second elongate lobe may illuminate user stations on the first side of the corridor and may be shaped such that gain is a maximum on the main axis of the second lobe and decreases progressively in an opposite angular direction (such as anticlockwise), the third lobe may illuminate user stations on the second side of the corridor and may be shaped such that gain is a maximum on the main axis of the third lobe and decreases progressively in the second angular direction and the fourth lobe may illuminate user stations on the second side of the corridor and may be shaped such that gain is a maximum on the main axis of the fourth lobe and decreases progressively in the first angular direction.

At least some of the lobes may be asymmetrical about its respective main axis.

According to another aspect of the invention there is provided a method for providing communication services to user stations which are spaced on each of a first side and a second opposed side of an elongate corridor having a longitudinal axis and extending between an upstream region and a downstream region, the method comprising, at a first corridor node:
using a first antenna arrangement having a first radiation pattern for transmitting radio signals in a first frequency band, the radiation pattern comprising at least a first elongate lobe having a main axis;
using the first elongate lobe to illuminate user stations associated with the first corridor node on one of the first side and the second side of the corridor;
using a reflector which is spaced from the antenna arrangement to reflect signals impinging on the reflector in accordance with a first reflected radiation pattern comprising at least one reflected elongate lobe having a main axis; and
using the at least one reflected elongate lobe to illuminate user stations associated with the first corridor node on the other of the first side and the second side of the corridor.

The first radiation pattern may comprise a second elongate lobe having a main axis and which is angularly offset from the first elongate lobe.

The method may comprise directing the main axis of the first elongate lobe upstream towards a first region along the corridor which is on the first side of the corridor to illuminate user stations associated with the first corridor node between the first region and the first corridor node, the first elongate lobe being shaped such that gain is highest in the direction of the first region and such that the user stations associated with the first corridor node between the first region and the first corridor node which are progressively closer to the first corridor node are illuminated with progressively lesser gain; directing the main axis of the second elongate lobe downstream towards a second region along the corridor which is on the first side of the corridor to illuminate user stations associated with the first corridor node between the second region and the first corridor node, the second elongate lobe being shaped such that gain is highest in the direction of the second region and such that the user stations associated with the first corridor node between the second region and the first corridor node which are progressively closer to the first corridor node are illuminated with progressively lesser gain; and the at least one reflected lobe may comprise at least one of a third elongate lobe having a main axis and a fourth elongate lobe having a main axis, the main axis of the third elongate lobe being directed upstream towards a third region along the corridor which is on the second side of the corridor to illuminate user stations associated with the first corridor node between the third region and the first corridor node, the third elongate lobe being shaped such that gain is highest in the direction of the third region and such that the user stations associated with the first corridor node between the third region and the first corridor node which are progressively closer to the first corridor node are illuminated with progressively lesser gain; and the main axis of the fourth elongate lobe being directed downstream towards a fourth region along the corridor which is on the second side of the corridor to illuminate user stations associated with the second corridor node between the fourth region and the second corridor node, the fourth elongate lobe being shaped such that gain is highest in the direction of the fourth region and such that the user stations associated with the first corridor node between the fourth region and the first corridor node which are progressively closer to the first corridor node are illuminated with progressively lesser gain.

The method may also comprise, at each user station associated with the first corridor node, using a directional antenna which is aimed at the first corridor node, to communicate with the first corridor node.

The method may further comprise, at a second corridor node, which is provided in spaced relation relative to the first corridor node along the corridor:
using a second antenna arrangement having a second radiation pattern for transmitting radio signals in a second frequency band, the second radiation pattern comprising at least a first elongate lobe having a main axis and a second elongate lobe having a main axis, the second elongate lobe being angularly offset from the first elongate lobe;
using a second reflector which is spaced from the second antenna arrangement to reflect signals impinging on the reflector in accordance with a second reflected radiation pattern comprising at least one of a third elongate lobe having a main axis and a fourth elongate lobe having a main axis;
directing: the main axis of the first elongate lobe upstream towards a region along the corridor which is on the first side of the corridor to illuminate user stations associated with the second corridor node between said region and the second corridor node, the first elongate lobe being shaped such that gain is highest in the direction of said region and such that the user stations associated with the second corridor node between said region and the second corridor node which are progressively closer to the second corridor node are illuminated with progressively lesser gain; the main axis of the second elongate lobe downstream towards a region along the corridor which is on the first side of the corridor intermediate the first node and the second node to illuminate user stations associated with the second corridor node between said region and the second corridor node, the second elongate lobe being shaped such that gain is highest in the direction of said region and such that the user stations associated with the second corridor node between said region and the second corridor node which are progressively closer to the second corridor node are illuminated with progressively lesser gain; the main axis of the third elongate lobe upstream towards a region on the second side of the corridor to illuminate user stations associated with the second corridor node on the second side of the corridor between said region and the second corridor node, the third elongate lobe being shaped such that gain is highest in the direction of said region and such that the user stations associated with the second corridor node between said region and the second corridor node which are progressively closer to the second corridor node are illuminated with progressively lesser gain; and the main axis of the fourth elongate lobe downstream towards a region along the corridor which is on the second side of the corridor intermediate the first corridor node and the second corridor node to illuminate user stations associated with the second corridor node between said region and the second corridor node, the fourth elongate main lobe being shaped such that gain is highest in the direction of said region and such that the user stations associated with the second corridor node between said region and the second corridor node which are progressively closer to the second corridor node are illuminated with progressively lesser gain; and
at each user station associated with the second corridor node, using a directional antenna which is aimed at the second corridor node, to communicate with the second corridor node.

The method may further comprise shaping the first lobe such that gain is a maximum on the main axis of the first lobe and decreases progressively in a first angular direction, shaping the second lobe such that gain is a maximum on the main axis of the second lobe and decreases progressively in an opposite angular direction, shaping the third lobe such that gain is a maximum on the main axis of the third lobe and decreases progressively in the second angular direction and shaping the fourth lobe such that gain is a maximum on the main axis of the fourth lobe and decreases progressively in the first angular direction.

### BRIEF DESCRIPTION OF THE ACCOMPANYING DIAGRAMS

The invention will now further be described, by way of example only, with reference to the accompanying diagrams wherein:

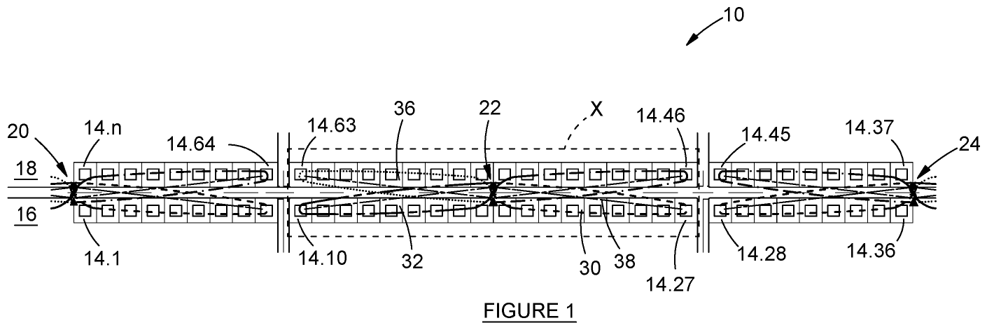

FIG. 1 is a diagrammatic representation of an example embodiment of a system for providing communication services to a plurality of user stations along a corridor;

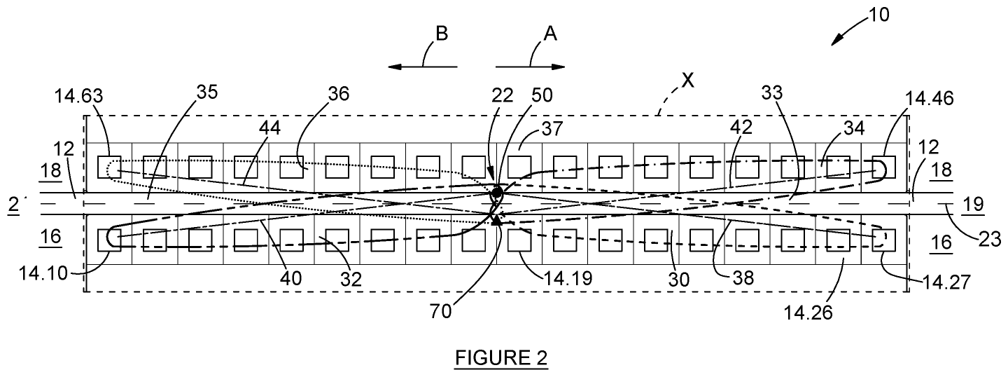

FIG. 2 is an enlargement of a part of the system in FIG. 1 which is enclosed by a rectangle in broken lines marked X in FIG. 1;

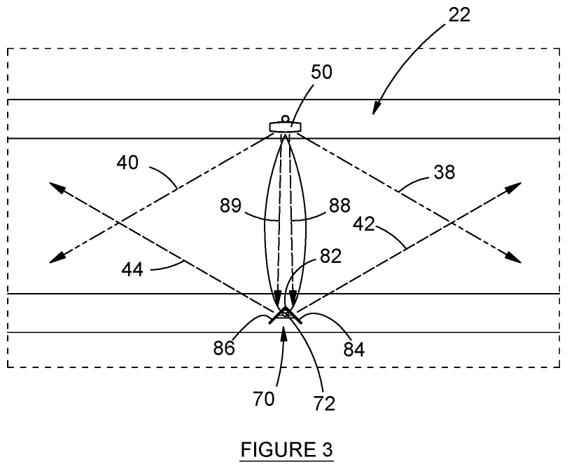

FIG. 3 is an enlarged view in plan of an example embodiment of a corridor node of the system;

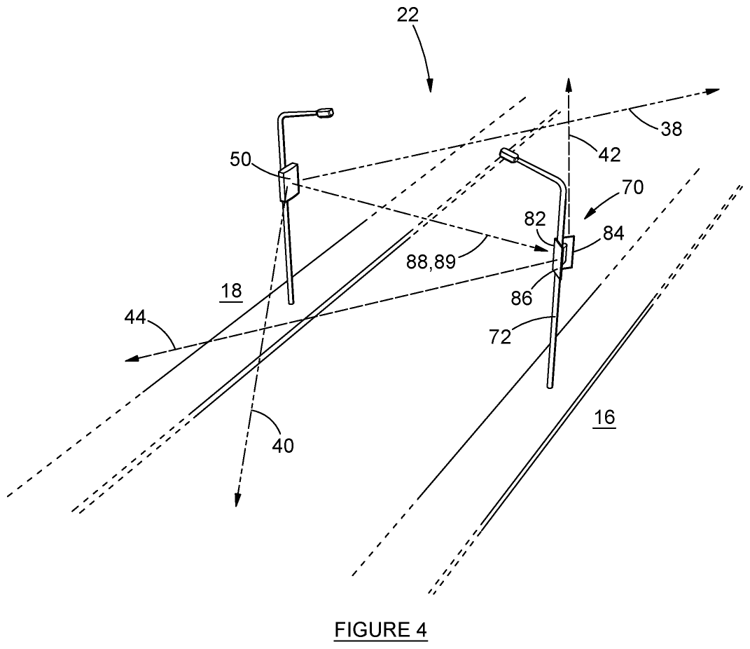

FIG. 4 is a diagrammatic perspective view of the corridor node;

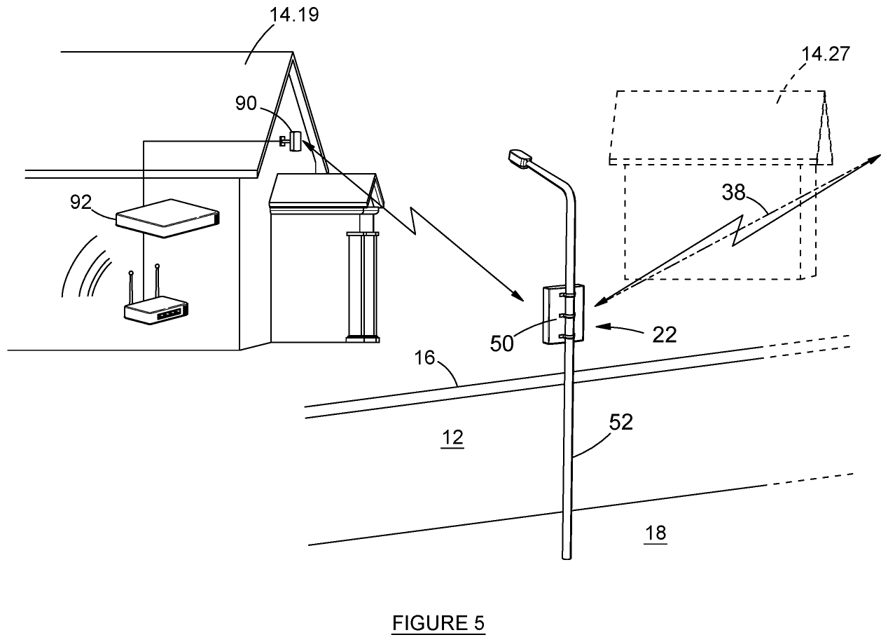

FIG. 5 is a diagrammatic representation of a data communication path between a corridor node of the system and a user station;

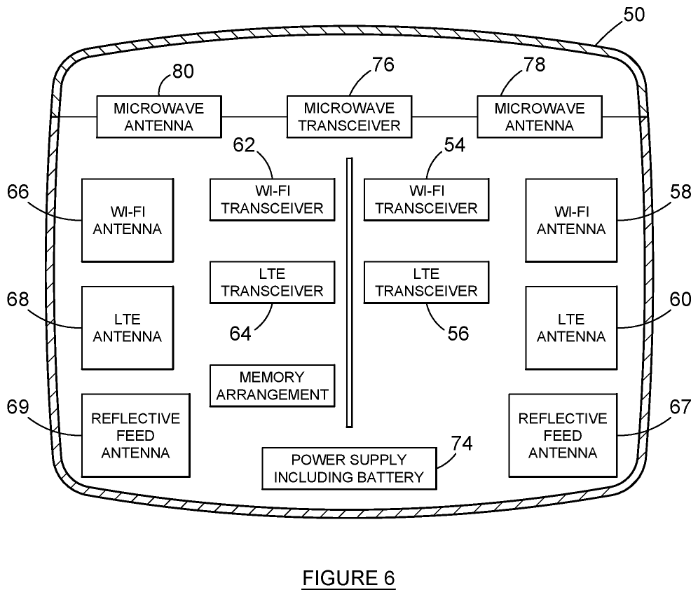

FIG. 6 is a basic block diagram of a transceiver arrangement and antenna arrangement forming part of at least some of the corridor nodes; and

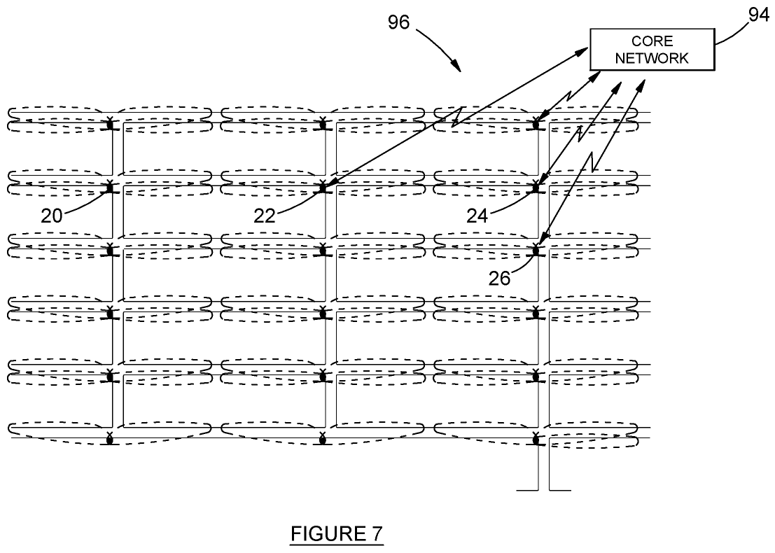

FIG. 7 illustrates the system and its connection to a core network via a backhaul network.

### DESCRIPTION OF A PREFERRED EMBODIMENT OF THE INVENTION

A system for providing communication services to user stations which are spaced along a corridor is generally designated by the reference numeral 10 in FIGS. 1 and 2.

In the example embodiment, the corridor is a suburban street 12 and the user stations are houses 14.1 to 14.n which are spaced on each of a first side 16 and a second opposed side 18 of the street. As best illustrated in FIG. 2, the corridor has an upstream region 19, a downstream region 21 and a longitudinal axis 23. The corridor may be any suitable channel or passage, including but not limited to a path, street, road etc.

Referring to FIG. 1, the system comprises at least a first corridor node 20, a second corridor node 22 and a third corridor node 24 provided sequentially in spaced relation along the street. The at least first, second and third corridor nodes comprise a respective radio transceiver arrangement (such as 54 and/or 56, 62 and/or 64 shown in FIG. 6) connected to associated antenna arrangements 58, 60, 66 and 68 (also shown in FIG. 6) and which will be described in more detail below with reference to FIG. 6.

Still referring to FIGS. 1 and 2, at least some of the nodes 20, 22 and 24 have radiation patterns comprising at least a first 30, a second 32, a third 34 and a fourth 36 elongate lobe having respective main axes 38, 40, 42 and 44. The antenna arrangement is such that in respect of the second corridor node, the main axis 38 of the first lobe 30 is directed upstream in a first general direction A along the street towards a region 14.27 which is on the first side 16 of the street intermediate the second corridor node 22 and the third corridor node 24, the main axis 40 of the second lobe 32 is directed downstream in a second direction B along the street towards a region 14.10 which is on the first side 16 of the street intermediate the first corridor node 20 and the second corridor node 22, the main axis 42 of the third lobe 34 is directed upstream in the first direction A along the street towards a region 14.46 which is on the second side 18 of the street intermediate the second corridor node 22 and the third corridor node 24 and the main axis 44 of the fourth lobe 36 is directed downstream in the opposite direction B along the street towards a region 14.63 which is on the second side 18 of the street intermediate the first corridor node 20 and the second corridor node 22.

Corridor nodes 20 to 24 may be similar or different in configuration. In the latter case, some corridor nodes may be of the configuration as described in the applicant's WO 2018/142236 A1 while others may be of the configuration described below.

Referring to FIG. 4, in an example embodiment, the second corridor node 22 comprises an enclosure 50 mounted on a post 52 located on the second side 18 of the street 12. The enclosure 50 houses the radio transceiver arrangement 54 and/or 56, 62 and/or 64 connected to an associated antenna arrangement 58 and/or 60, and 66 and/or 68. The antenna arrangements (58 and/or 60) and (66 and/or 68) further comprises a respective reflective feed antenna 67 and 69. The second node 22 further comprises a spaced reflector 70 mounted on a post 72 on the first side 16 of the street 12. The housing 50 and spaced reflector 70 may be located directly opposite one another.

Referring to FIG. 6, the enclosure 50 further houses a local power supply 74, including a rechargeable battery, which power supply may be configured to harvest solar energy in known manner. The transceiver arrangement may comprise at least one of Wi-Fi transceivers 54, 62 and LTE transceivers 56, 64 which are connected to Wi-Fi antennas 58, 66 and LTE antennas 60, 68 respectively. The radio transceiver arrangement transmits signals having a respective frequency band which band may be the same for both the Wi-Fi transceivers 54 and 62 and/or the same for both LTE transceivers. The housing 50 further comprises microwave link parts comprising a microwave transceiver 76 and microwave antennas 78 and 80, which will be referred to in further detail below.

Referring to FIGS. 3 and 4, the spaced reflector 70 in this example embodiment is V-shaped in configuration with an apex 82, a first flank 84 and a second flank 86. The apex 82 is directed towards the enclosure 50 and hence antenna arrangement inside the enclosure.

The antenna arrangement has a first radiation pattern comprising the first lobe 30 with main axis 38 directed as described above and the second lobe 32 with main axis 40 directed as described above. The second lobe 32 is angularly offset relative to the first lobe 30.

In use, the first flank 84 of the spaced reflector 70 reflects signals 88 impinging on the reflector from the reflective feed antenna 67 in accordance with a first reflected radiation pattern comprising the third lobe 34 with main axis 42 directed as described above. The second flank 86 of the spaced reflector 70 reflects signals 89 impinging on the reflector from the reflective feed antenna 69 to direct the main axis 44 of the fourth lobe 36 of the first reflected radiation pattern as described above.

Hence, each of the corridor nodes 20, 22, 24 provides two directional lobes in each of the general first direction A and the opposite direction B along the street 12. The arrangement is preferably such that the houses along the street are illuminated approximately uniformly, by ensuring the highest gain (on the main axis of a lobe) is in the direction of the house furthest from the corridor node and with lower gain to houses closer to the corridor node. As an example, and referring to FIGS. 1 and 2, the main axis 38 of the first lobe 30 is directed at house 14.27 on the first side 16 of the street and furthest away from corridor node 22. Houses 14.26 to 14.19 which are progressively closer to corridor node 22 on the first side 16 of the street, are illuminated with progressively lesser gain. Hence, the lobes are shaped such that the gain is high in the direction of the furthest house and progressively decreases in the direction of closer houses. The decrease may be in relation to distance from the corridor node, so that substantially the same or an equal signal level is received at each of the houses 14.19 to 14.27 illuminated or served by the lobe.

In addition to shaping the lobes as above, the radiation patterns are also shaped to ensure low gain in the direction of adjacent or neighbouring corridor nodes 20 and 24 of the system 10. In the context, low gain means gain values which would not degrade the performance of the adjacent corridor nodes 20 and 24 by interfering with the adjacent node. In the example embodiment of FIG. 2, there is a first at least partial null 33 between the first lobe 30 and the third lobe 34, a second at least partial null 35 between the second lobe 32 and the fourth lobe 36 and a third at least partial null 37 between the third lobe 34 and the fourth lobe 36. The first null 33 is directed at the third corridor node 24 and the second null 35 is directed at the first corridor node 20.

Each house, such as house 14.19 in FIG. 5, may be fitted with a suitable directional antenna 90 for cooperating with the corridor node, in this case corridor node 22. The antenna is connected in known manner to a router 92 and other known electronic equipment in the house, to facilitate data communication between the equipment and the corridor node 22 in known manner. The directional antennas on the user stations may play an important role in the successful operation of the system, since their directional patterns ensure high signal levels at the corridor nodes which they are associated with, whilst minimising interfering radiation to other user stations serviced by the same or other corridor nodes as well as minimising interference to adjacent corridor nodes and user stations, even when all of these operate within the same frequency band. For example, the furthest user station 14.27 serviced by corridor node 22 is close to the furthest user station 14.28 serviced by adjacent corridor node 24, but since user station 14.27 has a lobe pointing towards corridor node 22 and user station 14.28 has a lobe pointing nearly in the opposite direction, the signal from either corridor node 24 or user station 14.28 should have minimal effect on the signal received by user station 14.27 and vice versa.

Referring to FIG. 7, the corridor nodes 20, 22, 24 and 26 are connected in known manner to a core network 94 by a backhaul network 96, to be in bidirectional data communication with the core network. The backhaul network 96 may comprise any suitable infrastructure, such as fibre cables, wireless links, including microwave links, of which the above microwave transceiver 76 (shown in FIG. 6) of corridor node 22 and microwave antennas 78 and 80 (also shown in FIG. 6) may form part.

1. A system for providing communication services to user stations which are spaced on each of a first side and a second opposed side of an elongate corridor having a longitudinal axis and extending between an upstream region and a downstream region, the system comprising at least a first corridor node comprising:
a first radio transceiver arrangement which is connected to a first antenna arrangement, the first radio transceiver arrangement generating radio signals in a first frequency band, the first antenna arrangement having a first radiation pattern comprising at least a first elongate lobe having a main axis, the at least first elongate lobe, in use, illuminating user stations associated with the first corridor node on one of the first side and the second side of the corridor, and the first antenna arrangement comprising a reflective feed antenna; and
a first spaced reflector associated with the first antenna arrangement and for reflecting signals impinging from the reflective feed antenna in accordance with a first reflected radiation pattern comprising at least one reflected lobe for illuminating user stations associated with the first corridor node on the other of the first side and the second side of the corridor.

2. The system as claimed in claim 1 wherein the first antenna arrangement and the first spaced reflector are located on a line extending transversely to the longitudinal axis of the corridor.

3. The system as claimed in claim 2 wherein the first antenna arrangement is located on the second side of the corridor and the first spaced reflector is located on the first side of the corridor, directly opposite one another.

4. The system as claimed in claim 1, wherein the first radiation pattern comprises a second elongate lobe having a main axis and which is angularly offset from the first elongate lobe.

5. The system as claimed in claim 4 wherein the first antenna arrangement and first spaced reflector are configured such that the main axis of the first elongate lobe is directed upstream towards a first region along the corridor which is on the first side of the corridor to illuminate user stations associated with the first corridor node between the first region and the first corridor node, the first elongate lobe being shaped such that gain is highest in the direction of the first region and such that the user stations associated with the first corridor node between the first region and the first corridor node which are progressively closer to the first corridor node are illuminated with progressively lesser gain; the main axis of the second elongate lobe is directed downstream towards a second region along the corridor which is on the first side of the corridor to illuminate user stations associated with the first corridor node between the second region and the first corridor node, the second elongate lobe being shaped such that gain is highest in the direction of the second region and such that the user stations associated with the first corridor node between the second region and the first corridor node which are progressively closer to the first corridor node are illuminated with progressively lesser gain; wherein the at least one reflected lobe comprises at least one of a third elongate lobe having a main axis and a fourth elongate lobe having a main axis, the main axis of the third elongate lobe being directed upstream towards a third region along the corridor which is on the second side of the corridor to illuminate user stations associated with the first corridor node between the third region and the first corridor node, the third elongate lobe being shaped such that gain is highest in the direction of the third region and such that the user stations associated with the first corridor node between the third region and the first corridor node which are progressively closer to the first corridor node are illuminated with progressively lesser gain; and the main axis of the fourth elongate lobe being directed downstream towards a fourth region along the corridor which is on the second side of the corridor to illuminate user stations associated with the first corridor node between the fourth region and the first corridor node, the fourth elongate lobe being shaped such that gain is highest in the direction of the fourth region and such that the user stations associated with the first corridor node between the fourth region and the first corridor node which are progressively closer to the first corridor node are illuminated with progressively lesser gain.

6. The system as claimed in claim 1, comprising a directional antenna at each user station associated with the first corridor node and which directional antenna is aimed at the first corridor node.

7. The system as claimed in claim 1 comprising:
a second corridor node provided in spaced relation relative to the first corridor node along the corridor, the second corridor node comprising:
a second radio transceiver arrangement which is connected to a second antenna arrangement, the second radio transceiver arrangement generating radio signals in a second frequency band, the second antenna arrangement having a second radiation pattern comprising at least a first elongate lobe having a main axis, a second elongate lobe having a main axis and which second elongate lobe is angularly offset from the first elongate lobe, and the second antenna arrangement comprising a second reflective feed antenna; and
a second spaced reflector associated with the second antenna arrangement and for reflecting signals impinging from the second reflective feed antenna in accordance with a second reflected radiation pattern comprising at least one reflected lobe of the second corridor node for illuminating user stations on the other of the first side and the second side of the corridor;
the second antenna arrangement and second spaced reflector being configured such that the main axis of the first elongate lobe is directed upstream towards a region along the corridor which is on the first side of the corridor to illuminate user stations associated with the second corridor node between said region and the second corridor node, the first elongate lobe being shaped such that gain is highest in the direction of said region and such that the user stations associated with the second corridor node between said region and the second corridor node which are progressively closer to the second corridor node are illuminated with progressively lesser gain; the main axis of the second elongate lobe is directed downstream towards a region along the corridor which is on the first side of the corridor intermediate the first and the second corridor nodes to illuminate user stations associated with the second corridor node between said region and the second corridor node, the second elongate lobe being shaped such that gain is highest in the direction of said region and such that the user stations associated with the second corridor node between said region and the second corridor node which are progressively closer to the second corridor node are illuminated with progressively lesser gain; wherein the at least one reflected lobe of the second corridor node comprises at least one of a third elongate lobe having a main axis and a fourth elongate lobe having a main axis, the main axis of the third elongate lobe being directed upstream towards a region along the corridor which is on the second side of the corridor to illuminate user stations associated with the second corridor node between said region and the second corridor node, the third elongate lobe being shaped such that gain is highest in the direction of said region and such that the user stations associated with the second corridor node between said region and the second corridor node which are progressively closer to the second corridor node are illuminated with progressively lesser gain; and the main axis of the fourth elongate lobe being directed downstream towards a region along the corridor which is on the second side of the corridor intermediate the first and the second corridor nodes to illuminate user stations associated with the second corridor node between said region and the second corridor node, the fourth elongate main lobe being shaped such that gain is highest in the direction of said region and such that the user stations associated with the second corridor node between said region and the second corridor node which are progressively closer to the second corridor node are illuminated with progressively lesser gain; and
a directional antenna at each user station associated with the second corridor node and which directional antenna is aimed at the second corridor node.

8. The system as claimed in claim 1, wherein any one of the first spaced reflector and the second spaced reflector is V-shaped with an apex between first and second flanks of the spaced reflector.

9. The system as claimed in claim 8 wherein the apex is directed towards the associated antenna arrangement, wherein the first flank, in use, reflects impinging signals to direct the main axis of the third elongate lobe and wherein the second flank reflects impinging signals to direct the main axis of the fourth elongate lobe.

10. The system as claimed in claim 7, wherein the first and second frequency bands at least partially overlap.

11. The system as claimed in claim 7, wherein, in respect of any one of the first radiation pattern and the second radiation pattern, the first lobe illuminates user stations on the first side of the corridor and is shaped such that gain is a maximum on the main axis of the first lobe and decreases progressively in a first angular direction, the second lobe illuminates user stations on the first side of the corridor and is shaped such that gain is a maximum on the main axis of the second lobe and decreases progressively in an opposite angular direction, the third lobe illuminates user stations on the second side of the corridor and is shaped such that gain is a maximum on the main axis of the third lobe and decreases progressively in the second angular direction and the fourth lobe illuminates user stations on the second side of the corridor and is shaped such that gain is a maximum on the main axis of the fourth lobe and decreases progressively in the first angular direction.

12. A method for providing communication services to user stations which are spaced on each of a first side and a second opposed side of an elongate corridor having a longitudinal axis and extending between an upstream region and a downstream region, the method comprising, at a first corridor node:
using a first antenna arrangement having a first radiation pattern for transmitting radio signals in a first frequency band, the radiation pattern comprising at least a first elongate lobe having a main axis;
using the first elongate lobe to illuminate user stations associated with the first corridor node on one of the first side and the second side of the corridor;
using a reflector which is spaced from the antenna arrangement to reflect impinging signals in accordance with a first reflected radiation pattern comprising at least one reflected elongate lobe having a main axis; and
using the at least one reflected elongate lobe to illuminate user stations associated with the first corridor node on the other of the first side and the second side of the corridor.

13. The method according to claim 12 wherein the first radiation pattern comprises a second elongate lobe having a main axis and which is angularly offset from the first elongate lobe.

14. The method according to claim 13 comprising directing the main axis of the first elongate lobe upstream towards a first region along the corridor which is on the first side of the corridor to illuminate user stations associated with the first corridor node between the first region and the first corridor node, the first elongate lobe being shaped such that gain is highest in the direction of the first region and such that the user stations associated with the first corridor node between the first region and the first corridor node which are progressively closer to the first corridor node are illuminated with progressively lesser gain; directing the main axis of the second elongate lobe downstream towards a second region along the corridor which is on the first side of the corridor to illuminate user stations associated with the first corridor node between the second region and the first corridor node, the second elongate lobe being shaped such that gain is highest in the direction of the second region and such that the user stations associated with the first corridor node between the second region and the first corridor node which are progressively closer to the first corridor node are illuminated with progressively lesser gain; and wherein the at least one reflected lobe comprises at least one of a third elongate lobe having a main axis and a fourth elongate lobe having a main axis, the main axis of the third elongate lobe being directed upstream towards a third region along the corridor which is on the second side of the corridor to illuminate user stations associated with the first corridor node between the third region and the first corridor node, the third elongate lobe being shaped such that gain is highest in the direction of the third region and such that the user stations associated with the first corridor node between the third region and the first corridor node which are progressively closer to the first corridor node are illuminated with progressively lesser gain; and the main axis of the fourth elongate lobe being directed downstream towards a fourth region along the corridor which is on the second side of the corridor to illuminate user stations associated with the first corridor node between the fourth region and the first corridor node, the fourth elongate lobe being shaped such that gain is highest in the direction of the fourth region and such that the user stations associated with the first corridor node between the fourth region and the first corridor node which are progressively closer to the first corridor node are illuminated with progressively lesser gain.

15. The method according to claim 12 comprising, at each user station associated with the first corridor node, using a directional antenna which is aimed at the first corridor node, to communicate with the first corridor node.

16. The method according to claim 12 comprising, at a second corridor node, which is provided in spaced relation relative to the first corridor node along the corridor:
using a second antenna arrangement having a second radiation pattern for transmitting radio signals in a second frequency band, the second radiation pattern comprising at least a first elongate lobe having a main axis, a second elongate lobe having a main axis and which second elongate lobe is angularly offset from the first elongate lobe;
using a second reflector which is spaced from the second antenna arrangement to reflect impinging signals in accordance with a second reflected radiation pattern comprising at least one of a third elongate lobe having a main axis and a fourth elongate lobe having a main axis;
directing: the main axis of the first elongate lobe upstream towards a region along the corridor which is on the first side of the corridor to illuminate user stations associated with the second corridor node between said region and the second corridor node, the first elongate lobe being shaped such that gain is highest in the direction of said region and such that the user stations associated with the second corridor node between said region and the second corridor node which are progressively closer to the second corridor node are illuminated with progressively lesser gain; the main axis of the second elongate lobe downstream towards a region along the corridor which is on the first side of the corridor intermediate the first node and the second node to illuminate user stations associated with the second corridor node between said region and the second corridor node, the second elongate lobe being shaped such that gain is highest in the direction of said region and such that the user stations associated with the second corridor node between said region and the second corridor node which are progressively closer to the second corridor node are illuminated with progressively lesser gain; the main axis of the third elongate lobe upstream towards a region on the second side of the corridor to illuminate user stations associated with the second corridor node on the second side of the corridor between said region and the second corridor node, the third elongate lobe being shaped such that gain is highest in the direction of said region and such that the user stations associated with the second corridor node between said region and the second corridor node which are progressively closer to the second corridor node are illuminated with progressively lesser gain; and the main axis of the fourth elongate lobe downstream towards a region along the corridor which is on the second side of the corridor intermediate the first corridor node and the second corridor node to illuminate user stations associated with the second corridor node between said region and the second corridor node, the fourth elongate main lobe being shaped such that gain is highest in the direction of said region and such that the user stations associated with the second corridor node between said region and the second corridor node which are progressively closer to the second corridor node are illuminated with progressively lesser gain; and
at each user station associated with the second corridor node, using a directional antenna which is aimed at the second corridor node, to communicate with the second corridor node.

17. The method as claimed in claim 12 comprising shaping the first lobe such that gain is a maximum on the main axis of the first lobe and decreases progressively in a first angular direction, shaping the second lobe such that gain is a maximum on the main axis of the second lobe and decreases progressively in an opposite angular direction, shaping the third lobe such that gain is a maximum on the main axis of the third lobe and decreases progressively in the second angular direction and shaping the fourth lobe such that gain is a maximum on the main axis of the fourth lobe and decreases progressively in the first angular direction.
